(19) United States
(12) Patent Application Publication
(10) Pub. No.: US 2016/0011932 A1
(43) Pub. Date: Jan. 14, 2016

(54) Method for Monitoring Software in a Road Vehicle

(71) Applicant: Bayerische Motoren Werke Aktiengesellschaft, Muenchen (DE)

(72) Inventor: Mohamed ABO EL-FOTOUH, Muenchen (DE)

(21) Appl. No.: 14/796,123

(22) Filed: Jul. 10, 2015

(30) Foreign Application Priority Data
Jul. 11, 2014 (DE) 10 2014 213 503.6

(51) Int. Cl. G06F 11/07

(52) U.S. Cl. CPC G06F 11/0793; G06F 11/0736; G06F 11/0751; G06F 11/0772; G06F 11/079

(57) ABSTRACT

A method is provided for monitoring software in a road vehicle. The software has a plurality of code sections and each code section carries out at least one function. The method includes detecting whether an unexpected event has occurred during the execution of one of the code sections, the unexpected event being caused by the execution of the code in the code section, and/or checking whether a software section has been manipulated. The method transmits a message to a central unit outside the road vehicle if the unexpected event is detected and/or if it is detected that a software section has been manipulated. The method receives an instruction from the central unit to change the method of operation of the software in response to the detection of the unexpected event and/or the manipulation of the software section; and changes the method of operation of the software, while the software is being executed, in response to the instruction.

### CROSS REFERENCE TO RELATED APPLICATION

This application claims priority under 35 U.S.C. §119 from German Patent Application No. 10 2014 213 503.6, filed Jul. 11, 2014, the entire disclosure of which is herein expressly incorporated by reference.

### BACKGROUND AND SUMMARY OF THE INVENTION

The present invention relates to a method for monitoring software in a road vehicle and to a method for safely operating the motor vehicle despite a disturbed method of operation of the software.

Networked software is increasingly being used in road vehicles, for example automobiles. The increasing complexity of the software creates problems to the effect that the testing of the software becomes increasingly complex and there may be errors in the software of a delivered vehicle on account of the highly complex tests.

Furthermore, the software can be changed or manipulated by unauthorized persons in order to use functions which have not been enabled, for example.

In motor vehicles from the prior art, an error in the execution of the software during a workshop visit can be reported to a central unit via the diagnostic socket or, if the vehicle can communicate via a mobile network, via the mobile network. The software can be updated in a workshop after the error has been corrected.

For the user of the road vehicle, it is problematic that the user has to use faulty software until such software can be updated during a workshop visit of the motor vehicle.

DE 10 2011 004 634 A1 discloses a method which checks vehicle component state data for discrepancies by comparing them with historical vehicle component state data. If a discrepancy is determined, it is possible to generate a warning signal which indicates unauthorized use.

DE 10 2007 051 440 A1 discloses a method for enabling software, a server having checking means in order to determine whether requested software can be enabled in a vehicle on the basis of an actual configuration of the software, and means which can be used to calculate and transmit an enable code.

DE 10 2009 025 585 A1 relates to an apparatus for the decentralized function enabling of a control device for a vehicle having a production server and a crypto server for transmitting enable data. There is an enable module which can be connected between a central unit and the control device and can be used to carry out a limited number of enable operations independently of the central unit.

DE 10 2006 044 896 B3 discloses a manipulation remote diagnostic system for a vehicle, which has a control system which stores calibration data. As soon as it is determined that the calibration data have been changed, a manipulation indicator is generated.

The invention is based on the object of providing a method which makes it possible to continue to operate the road vehicle despite an error in the software or despite manipulation of the software.

This and other objects are achieved in accordance with embodiments of the invention.

A method according to the invention for monitoring software in a road vehicle, the software having a plurality of code sections and each code section carrying out at least one function, includes the act of detecting whether an unexpected event has occurred during the execution of one of the code sections, the unexpected event being caused by the execution of the code in the code section, and/or the act of checking whether a software section has been manipulated. A message is transmitted to a central unit outside the road vehicle if the unexpected event is detected and/or if it is detected that a software section has been manipulated. The road vehicle then receives an instruction from the central unit to change the method of operation of the software in response to the detection of the unexpected event and/or the manipulation of the software section. The method of operation of the software can be changed, while the software is being executed, in response to the instruction.

The software may include an individual process or a plurality of processes which are executed on a processor. In the sense of this invention, the expression “software” may also include a plurality of processes which are carried out by different processors, the processors being able to be situated in the same control unit and/or in different control units. The processes can communicate with one another using inter-program communication and/or using a network.

The unexpected event may be an unexpected termination of a process and/or an unexpected termination of a thread. A thread may be a subprocess of a process which is executed independently of another subprocess of the process by the same processor or a different processor of a control unit. The unexpected event may be the fact that a variable has a value outside a permissible range of values. Furthermore, the unexpected event may be the fact that an inter-process communication and/or an intra-process communication has/have failed. Furthermore, the unexpected event may be the fact that the jump to a code section has failed.

The unexpected event may have occurred on account of manipulation of a component and/or may be the determination of manipulation of a component. In the sense of this invention, the expression “manipulation of a component” comprises both manipulation of a control unit and a change in any desired component of the vehicle, for example a drive component, a brake, an engine or the like. The unexpected event may have occurred on account of manipulation of the software, for example at least one code in a code section. The unexpected event may also comprise the detection of manipulation of the software, for example at least one code in a code section.

The manipulation of the software section may be changing at least one code section, changing an at least digital content, and/or changing at least one configuration date. A digital content may be a medium, for example an audio and/or video medium. The manipulation may relate to the deactivation of copy protection. The configuration date may be stored in a configuration file.

The instruction to change the method of operation of the software can be transmitted in encrypted or coded form.

The method may include the act of analyzing the state of the software by way of a central unit. For example, the central unit may read a file and/or a memory content, in which the history of the sequence of a process is stored. Such files or memory areas are also referred to as traces or error log files in the field of software development. The historical data relating to the execution of a process can be loaded by the central unit from the road vehicle into the central unit for further analysis. The analysis can be carried out in an automated fashion.

The changing of the method of operation of the software may include the act of interrupting the execution of at least one code section for a predetermined period. For example, the software can be reconfigured by the instruction from the central unit such that the code section which caused the unexpected event is not executed. This configuration of the invention has the advantage that the road vehicle and the functions of the road vehicle are effected completely to the greatest possible extent and no unexpected software crashes occur. This relieves the load on the driver and also increases the safety of the road vehicle.

The changing of the method of operation of the software may include the termination of at least one process part of the software and the restarting at least of the terminated process part. This procedure is useful if the unexpected event has occurred randomly. This procedure is suitable, in particular, for a non-safety-critical function of the road vehicle, for example for a comfort function. This makes it possible to ensure that as many comfort functions of the road vehicle as possible are available. The expression “at least one process part” may comprise a process or a thread, that is to say a subprocess.

The changing of the method of operation of the software may include the interruption of the communication of at least one first code section. This procedure is helpful if failed communication caused the unexpected event. This procedure can also be used if it is assumed that the software has been manipulated and/or there is the risk of data from the road vehicle being transmitted using the software in an unauthorized manner. It is possible for the act of changing the method of operation to include both the termination of at least one process part of the software and the restarting of at least the terminated process part, the communication of at least one first code section being interrupted.

At least one second code section can communicate with another unit of the vehicle after the communication of the at least one first code section has been interrupted. This ensures that only that code section which caused the unexpected event does not communicate with another unit of the road vehicle and/or a unit outside the road vehicle. The changing of the method of operation of the software may include the act of executing the code section which caused the unexpected event again. This procedure can be used if the unexpected event occurred on account of a special and unexpected constellation, for example environmental conditions, conditions in the road vehicle, etc.

The act of changing the method of operation may include the act of updating and/or interchanging at least one code section and/or at least one software section. As a result, the original code section or a new (that is to say updated or revised) code section can be loaded. Furthermore, the original software section or a new (that is to say updated or revised) software section can be loaded.

The invention is now described in more detail with reference to the accompanying FIGURE which shows an exemplary and non-restrictive embodiment of the invention, in which case:

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 is a schematic diagram illustrating an exemplary embodiment of the invention.

### DETAILED DESCRIPTION OF THE DRAWING

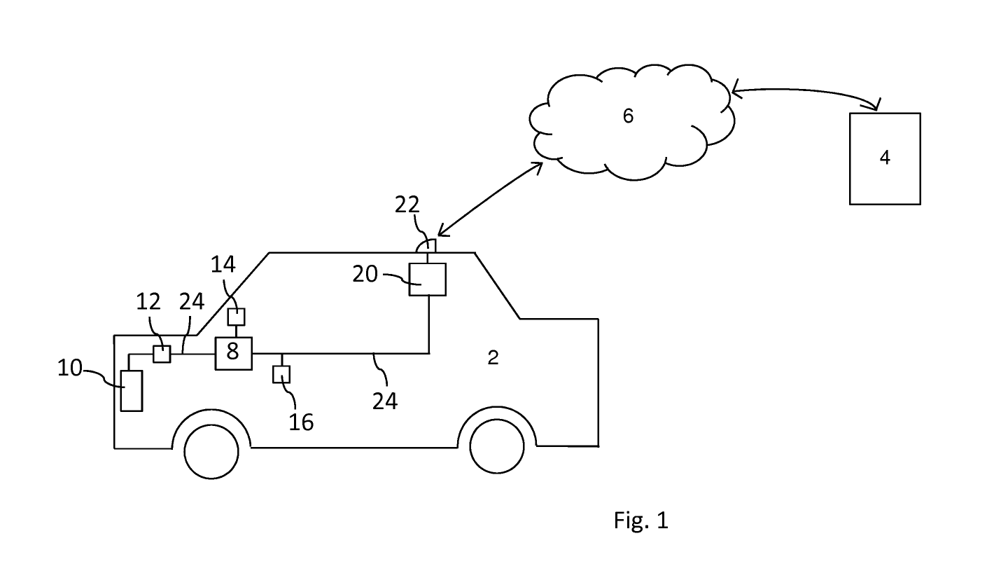

FIG. 1 shows a motor vehicle 2 which is connected to a central unit 4, for example a so-called back-end, via a network 6. The motor vehicle 2 includes a central control unit 8 which may be, for example, a central electronic control unit (electronic control unit). The motor vehicle also has an engine 10 which is connected to an engine controller 12, the engine controller 12 being able to be connected to the central electronic unit 8. The motor vehicle 2 also includes an electronic comfort system 14, for example a navigation system. The motor vehicle 2 may optionally also have a memory device 16 which stores program code and/or data relating to the motor vehicle 2. The central control unit 8, the engine controller 12, the electronic comfort device 14 and the memory device 16 may be directly or indirectly coupled to a transmitting device 20 and to an antenna 22 in order to communicate with the central device 4 via the network 6. It goes without saying that the transmission via the network 6 takes place using an encrypted communication channel in order to avoid security risks, for example the man-in-the-middle attacks in which an attempt can be made to load manipulated code into the motor vehicle 2.

Software may run on the central control unit 8, the engine controller 12 and the electronic comfort device 14. The software may have an operating system and at least one process. Each process may have subprocesses (threads). Each process and each subprocess may have a plurality of code sections containing instructions (code) which determine the method of operation of a processor.

The processes which run in the central control unit 8, the engine controller 12 and/or the electronic comfort device 14 may communicate with one another or may run independently of one another.

The processes may communicate with one another via a bus or a vehicle network 24.

If a process which runs in the central control unit 8, the engine controller 12 and/or the electronic comfort device 14 detects an unforeseen event during the execution of the code in a code section, the process outputs to the transmitting device 20 via the bus or the vehicle network 24 a signal indicating that an unusual event has occurred. The occurrence of the unusual event is transmitted to the central device 4 via the antenna 22 and the network 6.

The central device 4 may analyze the state of the software in the central control unit 8, the engine controller 12 and/or the electronic comfort device 14 via the network 6. For this purpose, it is possible to upload, for example, logs of the execution of a process, for example so-called traces and the content of log memory areas (log data), which may be situated in the central control unit 8, the engine controller 12, the electronic comfort device 14 and/or the memory device 16. The central device 4 can analyze the process execution log in order to determine a cause of the unexpected event in a manual and/or automated manner. As soon as the cause of the unexpected event has been determined, the central device 4 can instruct the central electronic unit 8, the engine controller 12 and/or the electronic comfort device 14 to change the method of operation of the software, that is to say at least one subprocess of the software, via the network 6. The changing of the method of operation of the software may be the fact that a process is terminated and is restarted. The changing of the method of operation may also be the fact that communication between components of the motor vehicle 2 or communication to the outside is interrupted. Furthermore, the change of the method of operation may be the fact that parts of the software, that is to say at least one process, are restarted at a suitable time. The suitable time may be the switching-off of the motor vehicle. The changing of the method of operation may also be the fact that the execution of a process or of a subprocess is interrupted for a predetermined period. The change of the method of operation may also comprise the fact that the code section which caused the unexpected event is executed repeatedly. Provision of a counter may be made, which counter monitors how often the code is executed again with the occurrence of the unexpected event. As soon as the code section which triggered the unexpected event is executed without the occurrence of the unexpected event, the code section is not executed again.

The central device 4 may be designed to instruct a plurality of motor vehicles 2 to change the method of operation of the software. This may be required, for example, in the case of implementation faults which constitute a safety risk or considerably restrict comfort.

The central device 4 may change the method of operation of the software of at least one motor vehicle 2 within a period of less than 6 hours, preferably less than 3 hours, very preferably less than 1 hour, more preferably within less than 30 minutes, most preferably within 15 minutes.

The central control unit 8, the engine controller 12 and/or the electronic comfort device 14 can send a message to the central device 4 via the network 6 when manipulation of the software and/or hardware is determined. The central device 4 can send an instruction to the software of the motor vehicle 2 via the network 6, said instruction stipulating how the method of operation of the software is changed. The method of operation can be changed in the manner described above. The change of the method of operation may also include the fact that at least the process whose program code has been manipulated is at least partially stopped and the communication of processes having manipulated code can also be interrupted since there is a risk of data from the motor vehicle 2 being transmitted to unauthorized third parties.

If it is determined that hardware of a motor vehicle has been manipulated, for example if the engine 10 has been manipulated, the change of the method of operation may be the fact that the engine 10 is operated with a reduced power output in order to avoid engine damage. Furthermore, a signal, for example an optical signal, can be used to inform the driver that there is manipulation, for example of a safety-critical system which may comprise an anti-lock braking system, a stability system or the like.

The central device 4 can be designed to change the method of operation of the software by changing at least one code section or the code for at least one process by loading, for example, the original code and/or a code with debugging into the relevant electronic device, for example into the central control unit 8, the engine controller 12 and/or the electronic comfort device 14.

The present invention has the advantage that there is a dynamic response to an unexpected event and/or manipulation. If the motor vehicle is stolen by an unauthorized third party, some functions may be deactivated. The driver may also be prevented from using manipulated software which may be a safety risk. It is additionally possible to avoid damage to the motor vehicle 2 in the case of implementation faults or the like. Finally, the warranty claims by the owner of the motor vehicle 2 can be restricted if manipulation is determined.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for monitoring software in a road vehicle, the software having a plurality of code sections and each code section carrying out at least one function, the method comprising the acts of:
detecting whether an unexpected event has occurred during execution of one of the code sections, the unexpected event being caused by the execution of code in the code section, and/or checking whether a software section has been manipulated;
transmitting a message to a central unit outside the road vehicle if the unexpected event is detected and/or if the software section has been manipulated;
receiving an instruction from the central unit to change the method of operation of the software in response to the detection of the unexpected event and/or the manipulation of the software section; and
changing the method of operation of the software, while the software is being executed, in response to the instruction.

2. The method according to claim 1, wherein the unexpected event comprises one or more of the following:
an unexpected termination of a process;
an unexpected termination of a thread;
a variable having a value outside a permissible range of values;
an inter-process communication that has failed;
an intra-process communication that has failed; or
a jump to a code section has failed, and/or
wherein the manipulation of the software section comprises one or more of the following:
changing at least one code section;
changing at least one digital content; or
changing at least one configuration date.

3. The method according to claim 1, wherein the unexpected event:
occurs on account of manipulation of a component;
comprises the detection of manipulation of a component;
occurs on account of software manipulation; and/or
comprises the detection of software manipulation.

4. The method according to claim 2, wherein the unexpected event:
occurs on account of manipulation of a component;
comprises the detection of manipulation of a component;
occurs on account of software manipulation; and/or
comprises the detection of software manipulation.

5. The method according to claim 1, further comprising the act of:
analyzing a state of the software by way of the central unit.

6. The method according to claim 4, further comprising the act of:
analyzing a state of the software by way of the central unit.

7. The method according to claim 1, wherein the changing of the method of operation of the software comprises the act of interrupting the execution of at least one code section for a predetermined period.

8. The method according to claim 6, wherein the changing of the method of operation of the software comprises the act of interrupting the execution of at least one code section for a predetermined period.

9. The method according to claim 1, wherein the changing of the method of operation of the software comprises the termination of at least one process part of the software and the restarting at least of the terminated process part.

10. The method according to claim 6, wherein the changing of the method of operation of the software comprises the termination of at least one process part of the software and the restarting at least of the terminated process part.

11. The method according to claim 1, wherein the changing of the method of operation of the software comprises the interruption of the communication of at least one first code section.

12. The method according to claim 6, wherein the changing of the method of operation of the software comprises the interruption of the communication of at least one first code section.

13. The method according to claim 11, wherein at least one second code section communicates with another unit of the road vehicle and/or a unit outside the road vehicle after the communication of the at least one first code section has been interrupted.

14. The method according to claim 12, wherein at least one second code section communicates with another unit of the road vehicle and/or a unit outside the road vehicle after the communication of the at least one first code section has been interrupted.

15. The method according to claim 1, wherein the changing of the method of operation of the software comprises the act of executing the code section which caused the unexpected event again.

16. The method according to claim 6, wherein the changing of the method of operation of the software comprises the act of executing the code section which caused the unexpected event again.

17. The method according to claim 1, wherein the changing of the method of operation comprises the act of updating and/or interchanging at least one code section and/or at least one software section.

18. The method according to claim 6, wherein the changing of the method of operation comprises the act of updating and/or interchanging at least one code section and/or at least one software section.
